(19) United States
(12) Patent Application Publication
(10) Pub. No.: US 2017/0180518 A1
(43) Pub. Date: Jun. 22, 2017

(54) AUTHENTICATION SYSTEM, METHOD, CLIENT AND RECORDING MEDIUM USING TCP SYNC PACKET

(71) Applicant: MARKANY INC., Seoul (KR)

(72) Inventor: Tae Am CHOI, Seongnam-si (KR)

(73) Assignee: MARKANY INC., Seoul (KR)

(21) Appl. No.: 15/015,401

(22) Filed: Feb. 4, 2016

(30) Foreign Application Priority Data
Dec. 22, 2015 (KR) 10-2015-0183430

(51) Int. Cl. H04L 29/08; H04L 29/06

(52) U.S. Cl. CPC H04L 69/324; H04L 69/16; H04L 69/326; H04L 67/141; H04L 67/42; H04L 63/0838

(57) ABSTRACT

Disclosed is an authentication method using a TCP sync packet. The authentication method includes: generating, by a client, a Single Packet Authentication (SPA) packet (first step); sending, by the client, the SPA packet generated in the first step in a TCP sync packet to a server (second step); analyzing, by the server, the SPA packet included in the TCP sync packet to determine whether the SPA packet is valid (third step); and establishing a communication session between the server and the client by the server sending the TCP acknowledgment (ACK) packet to the client (fourth step).

### CROSS REFERENCE TO RELATED APPLICATION

This application claims the benefit of Korean Patent Application No. 10-2015-0183430, filed Dec. 22, 2015, the content of which is incorporated herein by reference

### BACKGROUND OF THE INVENTION

1. Field of the Invention

The present invention generally relates to an authentication system, method, client, and recording medium using a Transmission Control Protocol (TCP) sync packet and, more particularly, to an authentication system, method, client, and recording medium using a TCP sync packet, which may streamline procedures and increase security by a client sending a Single packet Authentication (SPA) packet in a TCP sync packet to a server.

2. Description of the Related Art

FIG. 1 is a flowchart illustrating a procedure of an authentication method using a Single Packet Authentication (SPA) packet according to a conventional technology.

A client first generates an SPA packet and sends it to a server.

Upon reception of the SPA packet, the server determines whether the SPA packet is valid, and finishes the communication by dropping the SPA packet if the SPA packet is not valid, or inserts an Internet Protocol (IP) address of the client included in the SPA packet into its Access Control List (ACL) and sets a timer for a communication acceptance time for the IP address, if the SPA is valid.

Next, the client sends a Transmission Control Protocol (TCP) sync packet to the server.

The server then determines whether an IP address of a client included in the TCP sync packet has been registered in the ACL, and finishes the communication by dropping the TCP sync packet if the IP address has not been registered in the ACL, or inserts the TCP sync packet to a protocol stack and sends the TCP acknowledgment (ACK) packet to the client if the IP address has been registered in the ACL. After that, the client sends a response packet in return for reception of the TCP ACK packet, and thus the client and the server perform communication with each other. If the server determines based on the set timer that the communication acceptance time has expired, it deletes the IP address of the client from the ACL to maintain security.

In such a conventional authentication method, while authentication is implemented with SPA packets between the server and client, there may be a vulnerability in security because an IP address of the client is registered in the ACL depending on whether the SPA packet is valid or not, and subsequently, a method to refer only to the IP address of the client is employed when it comes to a request to connect a communication session. For example, if many clients send requests for connection to the server via a single IP share device, the clients have the same IP address, and there may be a security hole that permits a client that has not performed SPA authentication to access the server when the client requests to access the server while another client has performed SPA authentication and the communication acceptance time is not yet expired, because the IP address of the unauthenticated client is registered in the server.

Furthermore, in the conventional authentication method, authentication is implemented through relatively many steps and procedures of determining whether an SPA packet is valid or not, registering in the ACL, setting a timer, ACL acknowledgment for access request of a client, etc., which may burden the server and degrade response speed of the server.

### REFERENCE

Korean Patent Application Publication No. 10-2010-0103721 published on Sep. 27, 2010

### SUMMARY OF THE INVENTION

Accordingly, the present invention has been made keeping in mind the above problems occurring in the prior art, and an object of the present invention is to provide an authentication system, method, client, and recording medium using a Transmission Control Protocol (TCP) sync packet to streamline authentication procedures and improve response speed of a server by a client sending a Single packet Authentication (SPA) packet in a TCP sync packet to the server, thereby integrating an authentication-related process and a communication access process into one.

Another object of the present invention is to provide an authentication system, method, client, and recording medium using a TCP sync packet, which may prevent a security vulnerability from occurring in Internet Protocol (IP) address based authentication, by a server individually verifying and performing SPA authentication of each client while SPA authentication is implemented between the client and server.

In order to accomplish the above object, the present invention provides an authentication method using a Transmission Control Protocol (TCP) sync packet, which uses Single Packet Authentication (SPA) between a server and a client. The authentication method includes generating, by a client, an SPA packet (first step); sending, by the client, the SPA packet generated in the first step in a TCP sync packet to a server (second step); analyzing, by the server, the SPA packet included in the TCP sync packet to determine whether the SPA packet is valid (third step); and establishing a communication session between the server and the client by the server sending a TCP acknowledgment (ACK) packet to the client, if the SPA packet is valid (fourth step).

The SPA packet generated in the first step may include temporary authentication information generated in a One Time Password (OTP) scheme, which is preset between the server and the client.

The second step may include inserting the SPA packet into a payload of the TCP sync packet and sending the TCP sync packet with the inserted SPA packet to the server.

In order to accomplish the above object, the present invention also provides a computer-readable recording medium having a program embodied therein to carry out the method, the program being installed in a server or a client.

In order to accomplish the above object, an authentication system using a TCP sync packet, which uses SPA between a server and a client is also provided. The authentication system includes a client for generating an SPA packet and sending the SPA packet in a TCP sync packet to a server, and a server for analyzing the SPA packet included in the TCP sync packet sent from the client to determine whether the SPA packet is valid, wherein the server sends a TCP ACK packet to the client, if the SPA packet is valid, and thus a communication session is established between the server and the client.

The client may include a generator for generating an SPA packet; an inserter for inserting the SPA packet generated by the generator into a TCP sync packet; and a communication unit for sending the TCP sync packet including the SPA packet inserted by the inserter.

The generator may be configured to have the SPA packet include temporary authentication information generated in an OTP scheme preset with the server.

The inserter may be configured to insert the SPA packet into a payload of the TCP sync packet.

In order to accomplish the above object, a client for performing Transmission Control Protocol (TCP) communication through Single Packet Authentication (SPA) with a server is also provided. The client includes a generator for generating an SPA packet; an inserter for inserting the SPA packet generated by the generator into a TCP sync packet; and a communication unit for sending the TCP sync packet including the SPA packet inserted by the inserter.

The generator may be configured to have the SPA packet include temporary authentication information generated in an OTP scheme preset with the server.

The inserter may be configured to insert the SPA packet into a payload of the TCP sync packet.

### ADVANTAGEOUS EFFECTS

According to the present invention, authentication procedures are streamlined by a client sending an SPA packet in a TCP sync packet to a server to integrate an authentication related procedure and a communication access procedure into one, thereby improving response speed of a server.

Furthermore, a security vulnerability that may occur in IP address based authentication may be prevented by a server individually verifying and performing SPA authentication of a client while SPA authentication is implemented between the client and server.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a flowchart illustrating a procedure of an authentication method using a Single Packet Authentication (SPA) packet according to a conventional technology;

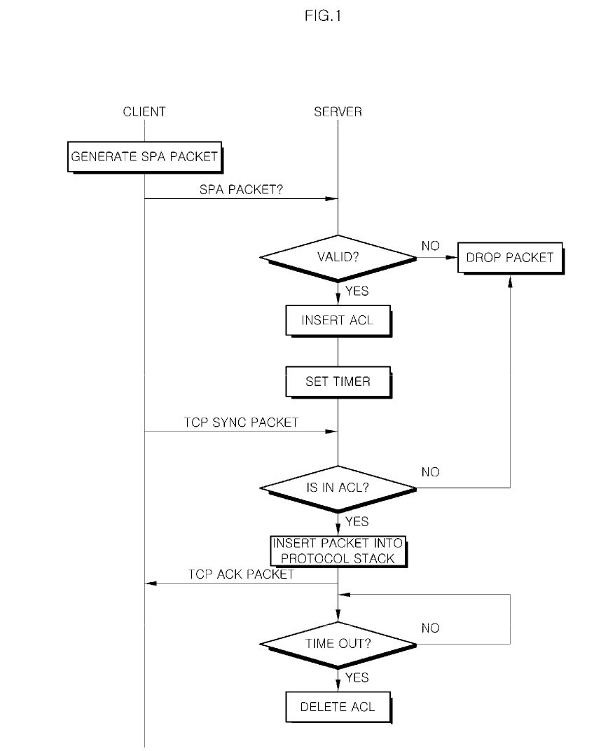

FIG. 2 is a flowchart illustrating a procedure of an authentication method using a Transmission Control Protocol (TCP) sync packet, according to an embodiment of the present invention; and

FIG. 3 is a block diagram of an authentication system using a TCP sync packet, according to an embodiment of the present invention.

### DESCRIPTION OF THE PREFERRED EMBODIMENTS

Features of the present invention will now be described with reference to accompanying drawings.

In the description of the present disclosure, if it is determined that a detailed description of commonly-used technologies or structures related to the embodiments of the present disclosure may unnecessarily obscure the subject matter of the invention, the detailed description will be omitted. When the term “connected” or “coupled” is used, a component may be directly connected or coupled to another component. However, unless otherwise defined, it is also understood that the component may be indirectly connected or coupled to the other component via another new component.

The terms and words used in the following description and claims are not limited to the bibliographical meanings but are merely used by the inventor to enable a clear and consistent understanding of the invention.

Accordingly, it should be apparent to those skilled in the art that the following description of exemplary embodiments of the present invention is provided for illustration purpose only and not for the purpose of limiting the disclosure as defined by the appended claims and their equivalents.

### 1. Authentication Method Using TCP Sync Packet

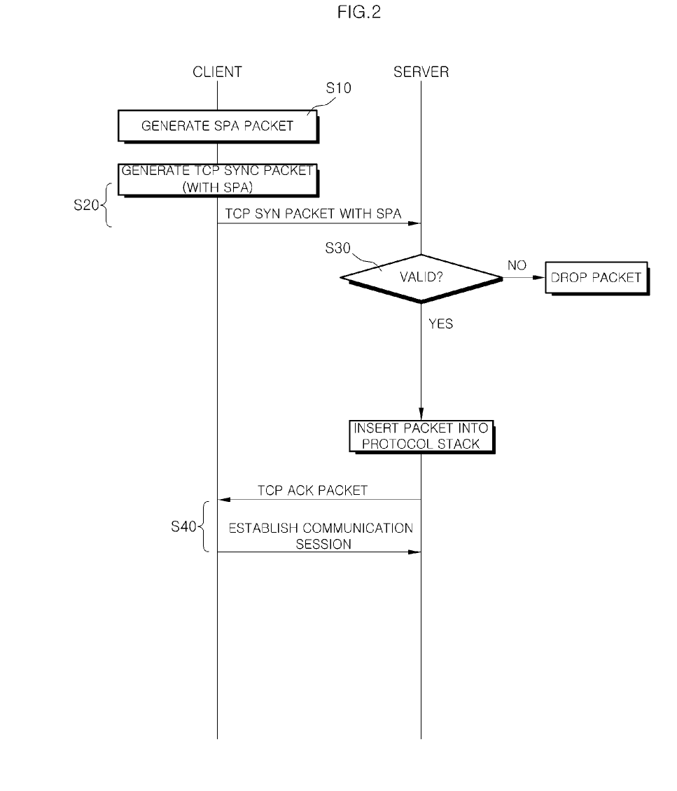

FIG. 2 is a flowchart illustrating a procedure of an authentication method using a Transmission Control Protocol (TCP) sync packet, according to an embodiment of the present invention.

Referring to FIG. 2, an authentication method using a TCP sync packet in accordance with an embodiment of the present invention includes: generating, by a client, a Single Packet Authentication (SPA) packet, in step S10; sending, by the client, the SPA packet generated in step S10 in a TCP sync packet to a server, in step S20; analyzing, by the server, the SPA packet included in the TCP sync packet to determine whether the SPA packet is valid, in step S30; and establishing a communication session between the server and the client by the server sending the TCP acknowledgment (ACK) packet to the client, if the SPA packet is valid, in step S40.

Specifically, the client first generates the SPA packet, in step S10.

The SPA packet generated in step S10 may include temporary authentication information generated in a One Time Password (OTP) scheme, which is preset between the server and the client.

Next, the client sends the SPA packet in the TCP sync packet to the server, in step S20.

More specifically, in step S20, the SPA packet is inserted into a payload of the TCP sync packet, and the TCP sync packet with the SPA packet (or TCP sync packet with SPA) is sent to the server.

As a specific method for inserting the SPA packet into the payload of the TCP sync packet, employed is a method to insert the SPA packet in the payload of the TCP sync packet by using Microsoft's Windows Filtering Platform (WFP) if an Operating System (OS) of the client is Windows-based, or using TAP if the OS of the client is Linux-based (including Android), to hook the TCP sync packet being sent to the server.

Next, the server analyzes the SPA packet included in the TCP sync packet to determine whether the SPA packet is valid, in step S30.

In this regard, the server determines whether the packet is valid by verifying the temporary authentication information included in the SPA packet, and finishes the communication by dropping the packet if the packet is not valid or completes authentication by putting the packet onto the server's protocol stack if the packet is valid.

In the case that the SPA packet is valid, a communication session is established between the server and the client by the server sending the TCP ACK packet to the client, in step S40.

In this regard, upon reception of the TCP ACK packet, the client sends a response packet to the server, and then communication may be performed between the server and the client.

The authentication method using a TCP sync packet in accordance with the embodiment of the present invention may be provided by a computer-readable recording medium having a program embodied therein to carry out the method, i.e., the authentication method may be provided in a form of a program or mobile application installed in a client 20, a server 20, or an independent control unit.

### 2. Authentication System Using TCP Sync Packet

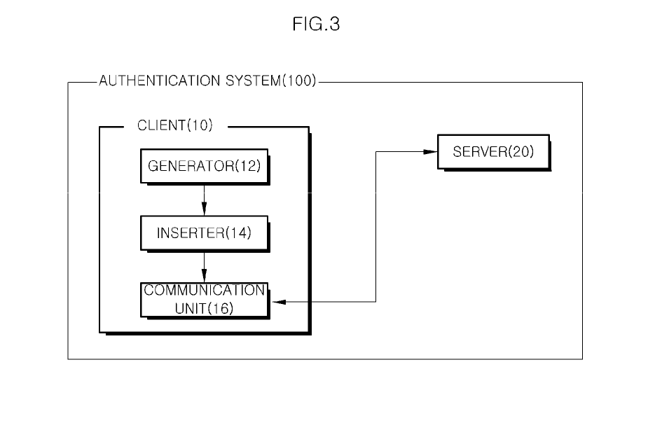

FIG. 3 is a block diagram of an authentication system using a TCP sync packet, according to an embodiment of the present invention.

Referring to FIG. 3, an authentication system 100 using a TCP sync packet in accordance with an embodiment of the present disclosure may include a client 10 for generating an SPA packet and sending the SPA packet in a TCP sync packet to a server, and a server 20 for analyzing the SPA packet included in the TCP sync packet sent from the client 10 to determine whether the SPA packet is valid.

The client 10 may be configured as a kind of terminal requesting access to the server 20 over a network, including a generator 12 for generating an SPA packet; an inserter 14 for inserting the SPA packet generated by the generator 12 into a TCP sync packet, and a communication unit 16 for sending the server 20 the TCP sync packet that includes the SPA packet inserted by the inserter 14.

The generator 12 may be configured to include temporary authentication information in the SPA packet, the temporary authentication information being generated in a One Time Password (OTP) scheme preset with the server 20.

The inserter 14 may serve to insert the SPA packet into a payload of the TCP sync packet, and may specifically be operated to insert the SPA packet in the payload of the TCP sync packet by using Microsoft's Windows Filtering Platform(WFP) if an Operating System (OS) of the client is Windows-based or using TAP if the OS of the client is Linux-based (including Android) to hook the TCP sync packet being sent to the server.

The communication unit 16 may send the server 20 the TCP sync packet that includes the SPA packet inserted by the inserter 14.

The server 20 may serve to analyze the SPA packet included in the TCP sync packet sent through the communication unit 16 to determine whether the packet is valid. Specifically, the server 20 may determine whether the packet is valid by verifying the temporary authentication information included in the SPA packet, and finish the communication by dropping the packet if the packet is not valid or complete authentication by putting the packet onto the server's protocol stack if the packet is valid.

If the server 20 determines that the SPA packet is valid, the server 20 may send a TCP ACK packet to the client 10 and thus a communication session is established between the server 20 and the client 10. Upon reception of the TCP ACK packet, the client 10 may send a response packet to the server 20, and then the server 20 and the client 10 perform communication with each other.

In accordance with the authentication system 100 using a TCP sync packet of the present invention, authentication is implemented for an individual packet for requesting communication in a way that the client 10 inserts an authentication packet, e.g., an SPA packet into a request communication packet, e.g., a TCP sync packet and sends the request communication packet with the authentication packet to the server 20, and the server then determines whether the packet is valid to determine whether to permit the client 10 to access the server 20. This may prevent occurrence of a vulnerability hole in authenticating the same IP address using e.g., a router, thereby increasing total security of a system.

As described above, an authentication system, method, client, and recording medium using a TCP sync packet in accordance with the present invention streamlines authentication procedures to improve response speed of a server by a client sending an SPA packet in a TCP sync packet to the server, which integrates authentication related procedures and communication access procedures into one.

Furthermore, a security vulnerability that may occur in IP address based authentication may be prevented by a server individually verifying and performing SPA authentication of a client while SPA authentication is implemented between the client and server.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An authentication method using a Transmission Control Protocol (TCP) sync packet, which uses Single Packet Authentication (SPA) between a server and a client, the authentication method comprising:
generating, by a client, an SPA packet (first step);
sending, by the client, the SPA packet generated in the first step in a TCP sync packet to a server (second step);
analyzing, by the server, the SPA packet included in the TCP sync packet to determine whether the SPA packet is valid (third step); and
establishing a communication session between the server and the client by the server sending a TCP acknowledgment (ACK) packet to the client, if the SPA packet is valid (fourth step).

2. The authentication method of claim 1,
wherein the SPA packet generated in the first step comprises temporary authentication information generated in a One Time Password (OTP) scheme, which is preset between the server and the client.

3. The authentication method of claim 1,
wherein the second step comprises inserting the SPA packet into a payload of the TCP sync packet and sending the TCP sync packet with the inserted SPA packet to the server.

4. A computer-readable recording medium having a program embodied therein to carry out the method of claim 1, the program being installed in a server or a client.

5. An authentication system using a Transmission Control Protocol (TCP) sync packet, which uses Single Packet Authentication (SPA) between a server and a client, the authentication system comprising:
a client for generating an SPA packet and sending the SPA packet in a TCP sync packet to a server, and
a server for analyzing the SPA packet included in the TCP sync packet sent from the client to determine whether the SPA packet is valid,
wherein the server sends a TCP acknowledgment (ACK) packet to the client, if the SPA packet is valid, and thus a communication session is established between the server and the client.

6. The authentication system of claim 5, wherein the client comprises
a generator for generating an SPA packet;
an inserter for inserting the SPA packet generated by the generator into a TCP sync packet; and
a communication unit for sending the TCP sync packet including the SPA packet inserted by the inserter.

7. The authentication system of claim 6,
wherein the generator is configured to have the SPA packet include temporary authentication information generated in a One Time Password (OTP) scheme preset with the server.

8. The authentication system of claim 6,
wherein the inserter is configured to insert the SPA packet into a payload of the TCP sync packet.

9. A client for performing Transmission Control Protocol (TCP) communication through Single Packet Authentication (SPA) with a server, the client comprising:
a generator for generating an SPA packet;
an inserter for inserting the SPA packet generated by the generator into a TCP sync packet; and
a communication unit for sending the TCP sync packet including the SPA packet inserted by the inserter.

10. The client of claim 9,
wherein the generator is configured to have the SPA packet include temporary authentication information generated in a One Time Password (OTP) scheme preset with the server.

11. The client of claim 9,
wherein the inserter is configured to insert the SPA packet into a payload of the TCP sync packet.
